(19) United States
(12) Patent Application Publication
(10) Pub. No.: US 2024/0319376 A1
(43) Pub. Date: Sep. 26, 2024

(54) SIGNAL PROCESSING APPARATUS, SIGNAL PROCESSING METHOD, AND PROGRAM

(71) Applicant: SONY SEMICONDUCTOR SOLUTIONS CORPORATION, KANAGAWA (JP)

(72) Inventor: TOSHIHISA MIYAKE, KANAGAWA (JP)

(21) Appl. No.: 18/259,401

(22) PCT Filed: Dec. 22, 2021
(86) PCT No.: PCT/JP2021/047512

§ 371 Date: Jun. 27, 2023

(30) Foreign Application Priority Data
Jan. 5, 2021 (JP) 2021-000373

(51) Int. Cl. G01S 17/894; G01S 7/481; G01S 7/4911; G01S 7/4915

(52) U.S. Cl. CPC G01S 17/894; G01S 7/4816; G01S 7/4911; G01S 7/4915

(57) ABSTRACT

The present technology relates to a signal processing apparatus, a signal processing method, and a program that enable highly accurate distance measurement over a wide range. A signal processing apparatus calculates a distance to a subject on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and generates a distance image, sets a target area targeted for exposure control for measuring a distance by use of modulated light at a second frequency, on the basis of a first distance image generated at the time of measuring a distance by use of modulated light at a first frequency, and calculates the second frequency on the basis of the target area. The present technology can be applied to a distance measuring apparatus that measures distances by use of a sensor.

### TECHNICAL FIELD

The present technology relates to a signal processing apparatus, a signal processing method, and a program, and more particularly relates to a signal processing apparatus, a signal processing method, and a program that enable highly accurate distance measurement over a wide range.

### BACKGROUND ART

A range of a distance that can be measured with an iTime of Flight (ToF) type sensor (hereinafter referred to as the iToF sensor) depends on a light source used for image capture.

Hence, a technique has been proposed which uses a plurality of modulation frequencies (hereinafter also simply referred to as the frequencies) to capture an image on a frame by frame basis, synthesizes the images, and therefore extends a measurable distance and increases distance measurement accuracy (refer to Patent Document 1).

Furthermore, the distance measurement accuracy depends on not only the frequency but also the strength of the amount of light received by the iToF sensor.

Therefore, in a case where the current iToF sensor uses a light source with different wavelengths to capture images, a technique in which an appropriate exposure time is calculated for each of the wavelengths and is applied to each of the frequencies, or a technique in which the calculation results of the exposure times are integrated and the same exposure time is set, is adopted.

### CITATION LIST

### Patent Document

Patent Document 1: Japanese Patent Application Laid-Open No. 2017-181488

### SUMMARY OF THE INVENTION

### Problems to be Solved by the Invention

However, even if the iToF sensor with a plurality of frequencies is used, in a case where the above-mentioned technique is adopted, there is a tendency that the distance measurement accuracy is high when a distance is measured in a short range area located close to the iToF sensor while the distance measurement accuracy is low when a distance is measured in a long range area located far from the iToF sensor.

The present technology has been achieved in view of such circumstances, and enables performing highly accurate distance measurement over a wide range.

### Solutions to Problems

A signal processing apparatus according to one aspect of the present technology includes: a distance measurement unit that calculates a distance to a subject on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and generates a distance image; an area setting unit that sets a target area targeted for exposure control for measuring a distance by use of modulated light at a second frequency, on the basis of a first distance image generated at the time of measuring a distance by use of modulated light at a first frequency; and a frequency calculation unit that calculates the second frequency on the basis of the target area.

In one aspect of the present technology, a distance to a subject is calculated on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and a distance image is generated. A target area targeted for exposure control for measuring a distance by use of modulated light at a second frequency is then set on the basis of a first distance image generated at the time of measuring a distance by use of modulated light at a first frequency, and the second frequency is calculated on the basis of the target area.

### BRIEF DESCRIPTION OF DRAWINGS

FIG. 1 is a diagram illustrating a relationship between the light source frequency and measurable distance range of an iToF sensor.

FIG. 2 is a diagram illustrating distance measurement results based on a light source with different frequencies, and true values.

FIG. 3 is a diagram schematically illustrating distance measurement in a case where the same exposure time is set in distance measurement using the light source with the different frequencies.

FIG. 4 is a diagram illustrating a procedure of a first method for selecting a target area.

FIG. 5 is a diagram illustrating a procedure of a second method for selecting a target area.

FIG. 6 is a diagram illustrating a procedure of a third method for selecting a target area.

FIG. 7 is a block diagram illustrating a configuration example of a first embodiment of an iToF sensor to which the present technology is applied.

FIG. 8 is a diagram illustrating a first distance measurement range as viewed from the position of the sensor.

FIG. 9 is a diagram illustrating an example of a case where the first distance measurement range from the near side to the far side in FIG. 8 is viewed from the front.

FIG. 10 is a flowchart explaining the processes of the iToF sensor of FIG. 7.

FIG. 11 is a flowchart explaining a frequency calculation process in step S14 of FIG. 10.

FIG. 12 is a block diagram illustrating a configuration example of a second embodiment of an iToF sensor to which the present technology is applied.

FIG. 13 is a flowchart explaining the processes of the iToF sensor of FIG. 12.

FIG. 14 is a block diagram illustrating a configuration example of a computer.

### MODE FOR CARRYING OUT THE INVENTION

Hereinafter, a mode for carrying out the present technology is described. The description is given in the following order:
1. Current Technology
2. Techniques of Present Technology
3. First Embodiment (Basic Configuration)
4. Second Embodiment (A Plurality of Light Emitting Units)
5. Others

### <<1. Current Technology>>

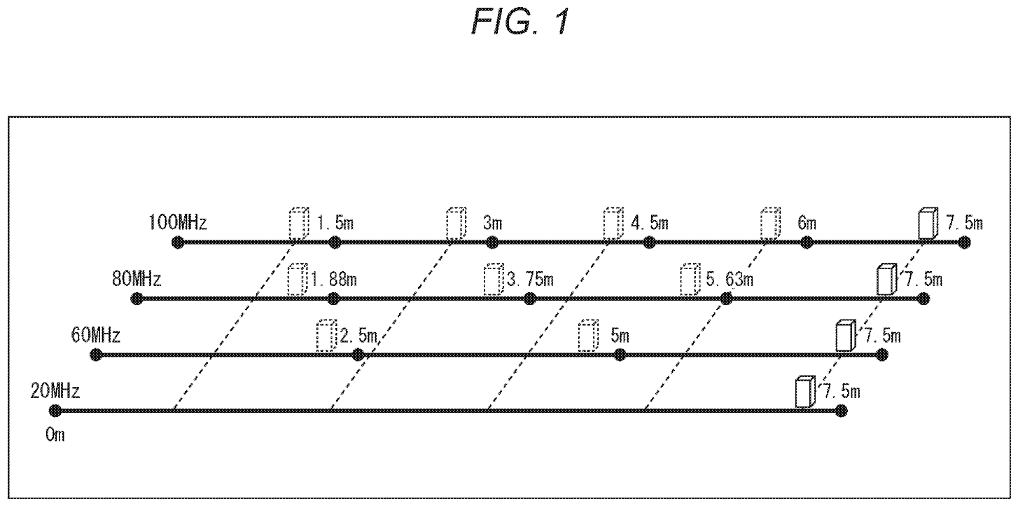

FIG. 1 is a diagram illustrating a relationship between the modulation frequency and measurable distance range of an iToF sensor.

The iToF sensor measures a distance by use of modulated light at a predetermined modulation frequency, in other words, captures an image by use of modulated light at a predetermined modulation frequency and measures a distance by use of the distance image obtained by the image capture. Specifically, the iToF sensor receives reflected light that is modulated light modulated at a predetermined modulation frequency, emitted, and reflected off a subject, accumulates the amount of light received as the amount of electric charge, generates a distance image by use of the outputted RAW data, and then measures a distance. Note that hereafter the modulation frequency is simply referred to as a frequency, and the modulated light is also simply referred to as light.

FIG. 1 schematically illustrates measurable distance ranges in a case where the frequencies of light used by the iToF sensor to measure distances are 100 MHz, 80 MHz, 60 MHz, and 20 MHz in order from top to bottom. The iToF sensor is located at 0 m on the left.

In the case where the frequency of light is 100 MHz, the measurable distance range in one distance measurement is 1.5 m. Consequently, in this case, the measurable distance ranges from the iToF sensor are, for example, from 0 m to 1.5 m, from 1.5 m to 3 m, from 3 m to 4.5 m, from 4.5 m to 6 m, and from 6 m to 7.5 m.

In the case where the frequency of light is 80 MHz, the measurable distance range in one distance measurement is 1.88 m. Consequently, in this case, the measurable distance ranges from the iToF sensor are, for example, from 0 m to 1.88 m, from 1.88 m to 3.75 m, from 3.75 m to 5.63 m, and from 5.63 m to 7.5 m.

In the case where the frequency of light is 60 MHz, the measurable distance range in one distance measurement is 2.5 m. Consequently, in this case, the measurable distance ranges from the iToF sensor are, for example, from 0 m to 2.5 m, from 2.5 m to 5 m, and from 5 m to 7.5 m.

In the case where the frequency of light is 20 MHZ, the measurable distance range in one distance measurement is 7.5 m. Consequently, in this case, the measurable distance range from the iToF sensor is, for example, from 0 m to 7.5 m.

As described above, in the iToF sensor, the measurable distance range varies according to the frequency of light. Note that in a case where there is a plurality of measurable distance ranges, it is unknown that in which distance range a distance is measured in a relevant distance measurement.

Furthermore, as light has a frequency of which the measurable distance range in one distance measurement is a longer range, the accuracy of distance measurement with the light decreases. As light has a frequency of which the measurable distance range in one distance measurement is a shorter range, the accuracy of distance measurement with the light increases.

Hence, a technique has been proposed which increases the accuracy of distance measurement by synthesizing a distance measurement result based on light having a frequency at which a distance can be measured in a long range and a distance measurement result based on light having a frequency at which a distance can be measured in a short range.

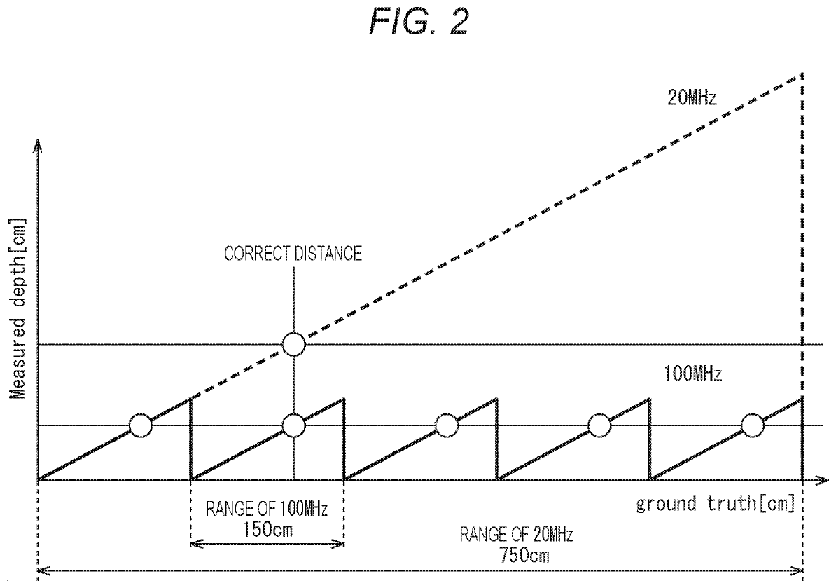

FIG. 2 is a diagram illustrating distance measurement results (Measured depth) based on light at different frequencies, and true values (ground truth).

FIG. 2 illustrates a graph of a distance measurement result based on light at 20 MHz and a distance measurement result based on light at 100 MHz. In the graph, the horizontal axis represents true values, and the vertical axis represents the distance measurement results.

The distance measurement with the light at 20 MHz is distance measurement in as long a range as 750 cm, and the distance measurement with the light at 100 MHz is distance measurement in as short a range as 150 cm. As a result, as described above, the distance measurement with the light at 100 MHz is more accurate than the distance measurement with the light at 20 MHz. Furthermore, the distance measurement with the light at 100 MHz is distance measurements in a plurality of (five) short ranges, and it is unknown that in which of the five short ranges a distance has been measured.

Consequently, the distance measurement result based on the light at 100 MHz, which is the closest to the distance measurement result based on the light at 20 MHz, is set as a correct distance. As a result, the accuracy of distance measurement can be increased.

However, in the current technology, the same exposure time is set for both of the distance measurement with the light at 20 MHz and the distance measurement with the light at 100 MHz.

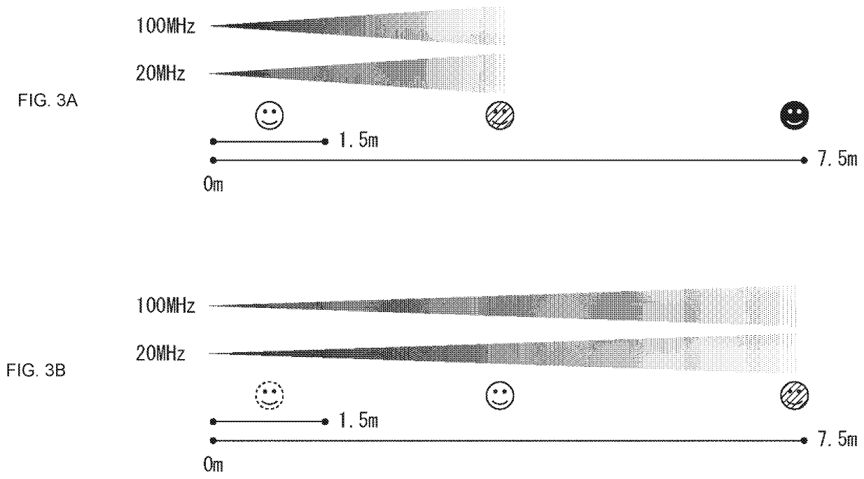

FIG. 3 is a diagram schematically illustrating distance measurement in a case where the same exposure time is set in the distance measurement with the light at 20 MHz and the distance measurement with the light at 100 MHz.

In FIG. 3, the iToF sensor is located at 0 m on the left, and the state of exposure in a range of 0 m to 7.5 m is illustrated.

Three types of face icons represent, in order from left to right, states of distance measurements in a short range area that is a short distance away from the position of the iToF sensor, in a medium range area that is a middle distance away from the position of the iToF sensor, and in a long range area that is a long distance away from the position of the iToF sensor.

Furthermore, the face icon indicated by a broken line represents that a distance can not be measured since light is saturated, which causes, for example, blown-out highlights. The face icons indicated by solid lines and the hatched face icons represent that a distance can be measured. In terms of pixel values obtained in the areas exhibiting the face icons, the hatched face icons have lower luminance than the face icons indicated by the solid lines. The face icon in black represents that a distance can not be measured due to beyond the reach of light. The same applies to the following drawings.

A of FIG. 3 is a diagram illustrating an example of a case where exposure is set for the near side as viewed from the position of the iToF sensor in a first distance measurement.

In the case of A of FIG. 3, since the exposure is set for the near side, a distance can be measured in the short range area and in the medium range area. However, in terms of the long range area, light does not reach the long range area, and it is difficult to measure a distance.

B of FIG. 3 is a diagram illustrating an example of a case where the exposure is set for the far side as viewed from the position of the iToF sensor.

In the case of B of FIG. 3, since the exposure is set for the far side, a distance can be measured in the medium range area and in the long range area. However, in terms of the short range area, light is saturated, and it is difficult to measure a distance.

As described above, under the present circumstances, in a case where distances are measured by use of light at different frequencies, the same exposure time is set for a light source that emits the light at the different frequencies. As a result, it is difficult to increase the accuracy of distance measurement in the short range area or the long range area, according to the area for which exposure is set.

### <<2. Techniques of Present Technology>>

Hence, in the present technology, a first distance measurement with light at a first frequency is performed. A target area for performing a second distance measurement with light at a second frequency is set on the basis of a first distance image generated by the first distance measurement to determine the second frequency on the basis of the set target area. In other words, the target area for performing the second distance measurement is also a target area used for exposure control for performing the second distance measurement.

There are three methods for selecting the above-mentioned target area, and each of the selection methods is described in turn.

### <First Selection Method>

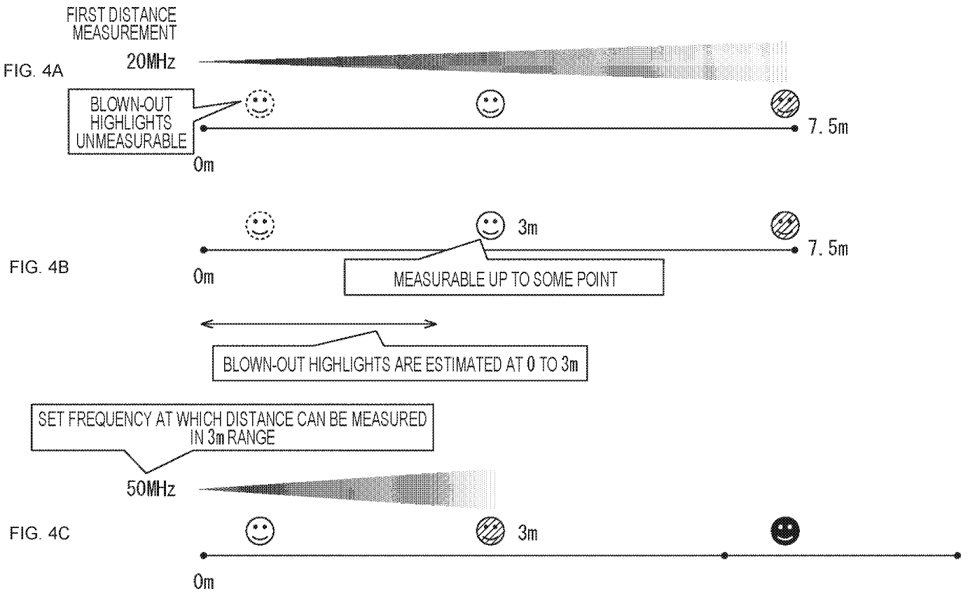

FIG. 4 is a diagram illustrating a procedure of a first method for selecting a target area.

As illustrated in A of FIG. 4, the first distance measurement with the light at the first frequency (20 MHz) is performed. In the case of FIG. 4, the exposure is set for the far side. As a result, in terms of the medium range area and the long range area, a distance can be measured. However, in terms of the short range area, light is saturated, which causes blown-out highlights and therefore it is difficult to measure a distance in the short range area.

As illustrated in B of FIG. 4, the first distance image, which is the first distance measurement result, is checked to estimate a 3 m area (from 0 m to 3 m) where pixel values failed to be acquired due to the blown-out highlights and need to be acquired by a second distance measurement, on the basis of a distance area (from 3 m to 7.5 m) where pixel values were successfully acquired. In the case of B of FIG. 4, the estimated 3 m area where pixel values need to be acquired is set as a target area for performing the second distance measurement with the light at the second frequency, and as a target area for the exposure control for performing the second distance measurement.

As illustrated in C of FIG. 4, 50 MHz at which a distance can be measured with high accuracy in the 3 m area being the target area is then determined as the second frequency.

### <Second Selection Method>

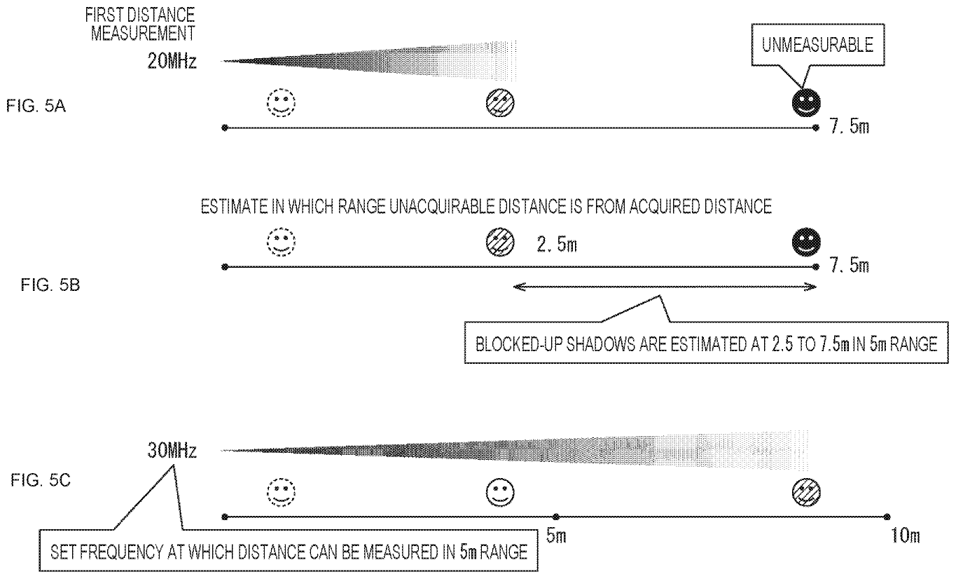

FIG. 5 is a diagram illustrating a procedure of a second method for selecting a target area.

As illustrated in A of FIG. 5, the first distance measurement with the light at the first frequency (20 MHz) is performed. It is essentially possible to measure a long distance with the first frequency. However, in the case of FIG. 5, the exposure is set for the near side. As a result, in terms of the short range area and the medium range area, a distance can be measured. However, in terms of the long range area, light does not reach, which causes blocked-up shadows and therefore a distance can not be measured.

As illustrated in B of FIG. 5, the first distance image, which is the first distance measurement result, is checked to estimate a 5 m area (from 2.5 m to 7.5 m) where pixel values failed to be acquired due to blocked-up shadows and need to be acquired by the second distance measurement, on the basis of the distance portion (from 0 m to 2.5 m) where pixel values were successfully acquired. In the case of B of FIG. 5, the estimated 5 m area where pixel values need to be acquired is set as the target area.

As illustrated in C of FIG. 5, the second frequency (30 MHz) at which a distance can be measured with high accuracy in the 5 m area being the target area is then determined.

### <Third Selection Method>

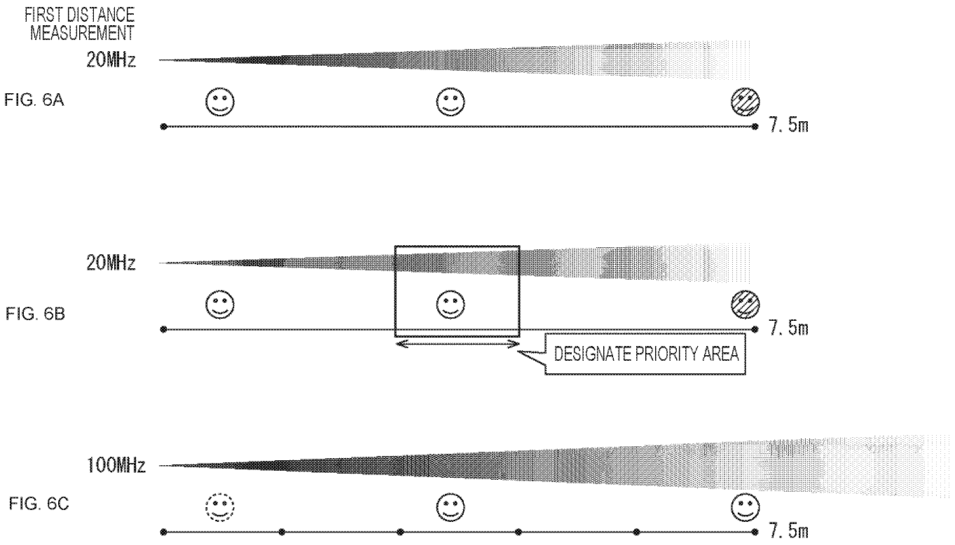

FIG. 6 is a diagram illustrating a procedure of a third method for selecting a target area.

As illustrated in A of FIG. 6, the first distance measurement with the light at the first frequency (20 MHZ) is performed. In this case, since the exposure is set for the middle distance, a distance can be measured on the whole, that is, in the short range area, the medium range area, and the long range area. However, it cannot be said that the accuracy is high.

As illustrated in B of FIG. 6, a user designates a distance (priority distance) or area to which he/she desires to give a high priority in acquisition while checking the first distance image, which is the first distance measurement result. Consequently, a 1 m area (from 2.0 m to 3.0 m) where pixel values need to be acquired by the second distance measurement is estimated. In the case of B of FIG. 6, the estimated 1 m area where pixel values need to be acquired is set as the target area.

As illustrated in C of FIG. 6, the second frequency (100 MHz) at which a distance can be measured with high accuracy in the 1 m area being the target area is determined.

The second distance measurement with the second frequency determined as described above is performed, and a distance image obtained by synthesizing the first distance image generated by the first distance measurement and a second distance image generated by the second distance measurement is outputted. Therefore, distances can be measured with high accuracy over a wide range.

A specific description is given of the present technology below.

### <<3. First Embodiment (Basic Configuration)>>

<Configuration of iToF Sensor>

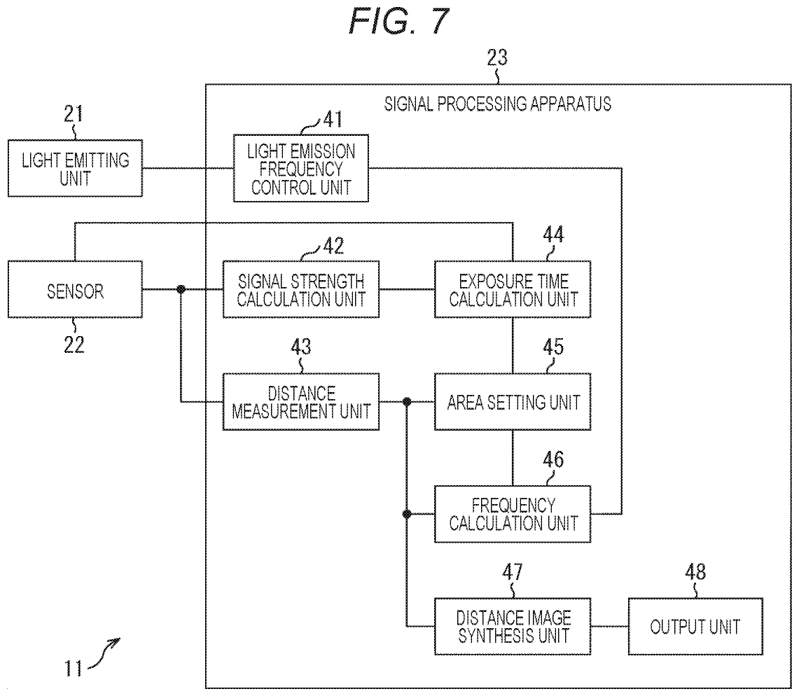

FIG. 7 is a block diagram illustrating a configuration example of a first embodiment of an iToF sensor to which the present technology is applied.

In FIG. 7, an iToF sensor 11 includes a light emitting unit 21, a sensor 22, and a signal processing apparatus 23.

The light emitting unit 21 emits modulated light modulated at a frequency set by the signal processing apparatus 23.

The sensor 22 includes a light receiving unit that, under the exposure control of the signal processing apparatus 23, receives reflected light being the modulated light that has been emitted by the light emitting unit 21 and reflected off a subject, and accumulates the amount of light received as the amount of electric charge. The sensor 22 outputs the amount of electric charge accumulated in the light receiving unit, to the signal processing apparatus 23.

The signal processing apparatus 23 includes a light emission frequency control unit 41, a signal strength calculation unit 42, a distance measurement unit 43, an exposure time calculation unit 44, an area setting unit 45, a frequency calculation unit 46, a distance image synthesis unit 47, and an output unit 48.

The light emission frequency control unit 41 sets a frequency determined by the frequency calculation unit 46 as a light emission frequency, and controls the light emitting unit 21 in such a manner as to emit light at the set frequency. Note that a preset frequency is used in the first distance measurement.

The signal strength calculation unit 42 calculates signal strength from the signal value of RAW data supplied from the sensor 22, and outputs the calculated signal strength to the exposure time calculation unit 44.

The distance measurement unit 43 calculates a distance from a subject on the basis of the RAW data supplied from the sensor 22 and the frequency, and generates a distance image. The distance measurement unit 43 outputs the generated distance image to the area setting unit 45, the frequency calculation unit 46, and the distance image synthesis unit 47.

The exposure time calculation unit 44 calculates an exposure time for the next frame in such a manner that the signal strength supplied from the signal strength calculation unit 42 is at an appropriate level. The exposure time calculation unit 44 performs the exposure control of the sensor 22 for the calculated exposure time. Note that a preset exposure time is used in distance measurement for the first frame. Furthermore, the exposure control of the sensor 22 may include calculating a necessary amount of light for exposure to control the calculated amount of light, in addition to the exposure time.

The area setting unit 45 acquires the pixel value closest in distance to the sensor 22 and the pixel value farthest in distance from the sensor 22 in the first distance image that is generated by the first distance measurement with the light at the first frequency and supplied from the distance measurement unit 43. The pixel value closest in distance to the sensor 22 is hereafter referred to as the closest value, and the value of the pixel value farthest in distance from the sensor 22 is hereafter referred to as the farthest value. Therefore, the area setting unit 45 can estimate a distance at which the pixel values cannot be acquired in the first distance measurement, and need to be acquired in the second distance measurement.

As described above with reference to FIGS. 4 to 6, the area setting unit 45 sets a target area for performing the second distance measurement with the light at the second frequency on the basis of, for example, the estimated distance range that needs to acquire the pixel values, or an area of interest designated in response to the user's operation. The target area is also a target area for performing the exposure control in the second distance measurement. The area setting unit 45 outputs information indicating the set target area to the exposure time calculation unit 44 and the frequency calculation unit 46.

The frequency calculation unit 46 calculates the second frequency at which a distance can be measured for the target area set by the area setting unit 45, and outputs the calculated second frequency to the light emission frequency control unit 41.

The distance image synthesis unit 47 synthesizes the first distance image generated by the first distance measurement with the light at the first frequency, and the second distance image generated by the second distance measurement with the light at the second frequency, the first and second distance images being supplied from the distance measurement unit 43, and outputs the synthesized distance image to the output unit 48.

The output unit 48 outputs the distance image supplied from the distance image synthesis unit 47 to an unillustrated subsequent stage.

### <Details of Frequency Calculation Process>

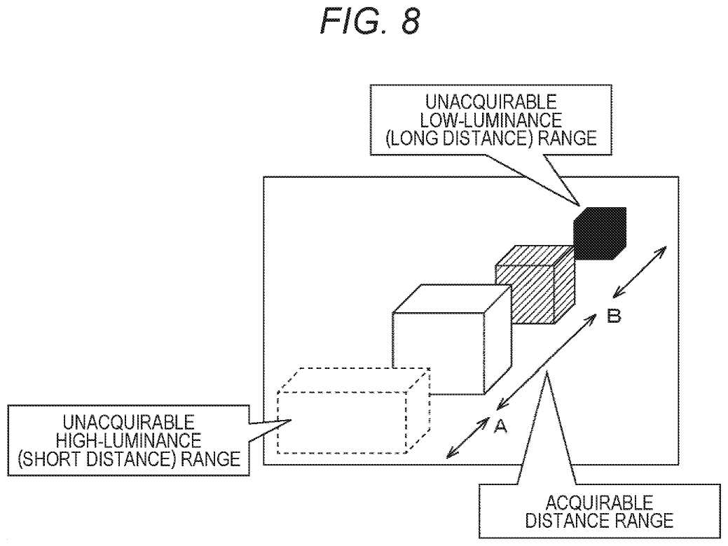

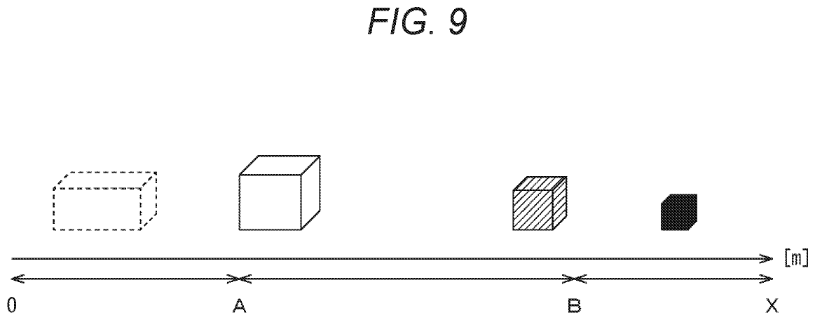

Next, a frequency calculation process is described with reference to FIGS. 8 and 9.

Initially, the area setting unit 45 acquires a closest value A and a farthest value B as illustrated in FIG. 8 by use of the first distance image supplied from the distance measurement unit 43 to estimate a distance range A-B that needs to acquire pixel values.

FIG. 8 is a diagram illustrating the range of the first distance measurement as viewed from the position of the sensor 22.

FIG. 8 illustrates a state in which the sensor 22 is located in the front on the left and the first distance measurement is performed from front left to back right. A represents a position in which the closest value in the first distance measurement is acquired, and B represents a position in which the farthest value in the first distance measurement is acquired.

In FIG. 8, a solid indicated by a dotted line forward of A is a solid located at short range relative to the sensor 22 and located in a range where a pixel value cannot be acquired due to high luminance (a saturated state) resulting from exposure. A solid indicated by a solid line and a hatched solid, the solids being illustrated between A and B, are solids located in a range where a pixel value can be acquired. A black-filled solid illustrated backward of B is a solid located at long range relative to the sensor 22 and located in a range where light resulting from exposure does not reach, hence low luminance, and therefore a pixel value cannot be acquired.

In other words, the distance range A-B is the range where a pixel value can be acquired. The left side, forward of A, is the range where a pixel value cannot be acquired due to high luminance. The right side, backward of B, is the range where a pixel value cannot be acquired due to low luminance, that is, a low confidence value.

FIG. 9 is a diagram illustrating an example of a case where the first distance measurement range from front left to back right in FIG. 8 is viewed from front right.

In FIG. 9, 0 at the left end represents the position of the sensor 22, and X at the right end represents the farthest position where the iToF sensor 11 can measure a distance.

In a case where the distance area where the acquisition is successful in the first distance measurement is the distance range A-B, a high-luminance area where a pixel value cannot be acquired is in a distance range 0-A, and a low-luminance area where a pixel value cannot be acquired is in a distance range B-X.

Consequently, the area setting unit 45 sets the distance range 0-A as the target area for the second distance measurement if it is necessary to acquire the pixel values of the high-luminance area where the pixel value failed to be acquired in the first distance measurement. Furthermore, the area setting unit 45 sets the distance range B-X as the target area for the second distance measurement if it is necessary to acquire the pixel value of the low-luminance area where the pixel value failed to be acquired in the first distance measurement.

In a case where the target area is the high-luminance area, the frequency calculation unit calculates the second frequency with which the distance range 0-A can be measured.

In a case where the target area is the low-luminance area, the frequency calculation unit calculates the second frequency with which the distance range B-X can be measured.

The relationship between the frequency and the distance is calculated by the following equation (1):

$$\begin{matrix}[ Math . 1 ] & \\ Measureable distance Range = \frac{c {T}_{p}}{2} & ( 1 )\end{matrix}$$

$$Pulse width Time {T}_{p} = \frac{1}{2 \cdot {F}_{m od}}$$

$$Modulated frequency {F}_{m od} = 1 / ( 2 * Range / c )$$

where, c represents high speed.

Note that the first distance image may be presented to the user, and an area of interest instructed by the user may be set as the target area.

Furthermore, it may be configured in such a manner as to recognize an object of which an image is captured in the first distance measurement, and the surrounding area of the recognized object may be set as the target area.

Moreover, in the above description, the example is described in which the second frequency is determined in a case where the first distance image includes an area where a pixel value failed to be obtained. However, it may be configured in such a manner as to determine a target area and a third frequency for performing a third distance measurement in a case where the first and second distance images include an area where a pixel value failed to be obtained. How to determine the target area and the third frequency for performing the third distance measurement is similar to the case of the target area and the second frequency for performing the second distance measurement.

<Operation of iToF Sensor>

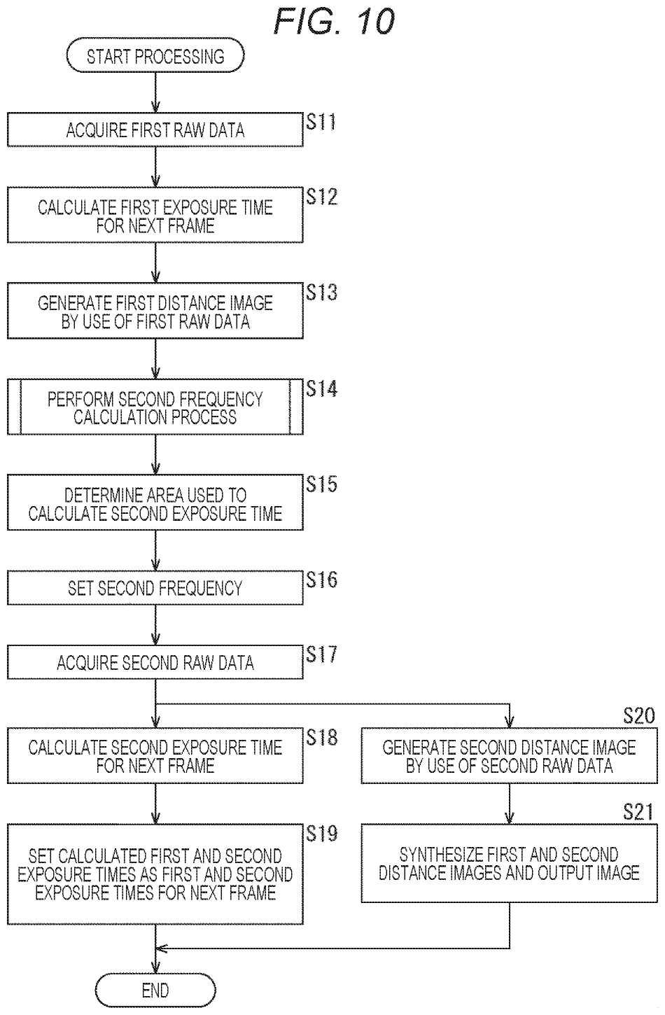

FIG. 10 is a flowchart explaining the processes of the iToF sensor 11.

In step S11, the iToF sensor 11 performs the first distance measurement with the modulated light at the first frequency, and acquires first RAW data.

Specifically, in the light emission frequency control unit 41, the first frequency is preset as the light emission frequency. The light emission frequency control unit 41 controls the light emitting unit 21 in such a manner as to emit light at the set first frequency. The light emitting unit 21 emits modulated light modulated at the first frequency set by the light emission frequency control unit 41. Under the exposure control by the exposure time calculation unit 44, the sensor 22 receives reflected light being the modulated light that has been emitted by the light emitting unit 21 and reflected off a subject. The sensor 22 accumulates the amount of light received, as the amount of electric charge, in the light receiving unit, and outputs the amount of electric charge accumulated in the light receiving unit, as the first RAW data, to the signal strength calculation unit 42 and the distance measurement unit 43.

In step S12, the signal strength calculation unit 42 calculates signal strength from the signal value of the first RAW data supplied from the sensor 22, and outputs the calculated signal strength to the exposure time calculation unit 44. The exposure time calculation unit 44 calculates a first exposure time for the first distance measurement with the modulated light at the first frequency for the next frame in such a manner that the signal strength supplied from the signal strength calculation unit 42 is at an appropriate level.

In step S13, the distance measurement unit 43 calculates a distance from the subject on the basis of the first RAW data supplied from the sensor 22 and the first frequency, and generates the first distance image. The distance measurement unit 43 outputs the generated first distance image to the area setting unit 45, the frequency calculation unit 46, and the distance image synthesis unit 47.

In step S14, the area setting unit 45 and the frequency calculation unit 46 perform a second frequency calculation process. The details of the second frequency calculation process are described below with reference to FIG. 9. In step S14, the area setting unit 45 sets a target area for the second distance measurement at the second frequency, and the frequency calculation unit 46 calculates the second frequency on the basis of the set target area. The area setting unit 45 outputs information indicating the set target area to the exposure time calculation unit 44 and the frequency calculation unit 46. The second frequency calculated by the frequency calculation unit 46 is outputted to the light emission frequency control unit 41.

In step S15, the exposure time calculation unit 44 determines the target area set by the area setting unit 45 as a target area used for second exposure control and calculation of a second exposure time for the second distance measurement with the modulated light at the second frequency for the next frame. In step S16, the light emission frequency control unit 41 sets the second frequency supplied by the frequency calculation unit 46, as the light emission frequency.

In step S17, the signal strength calculation unit 42 and the distance measurement unit 43 acquire second RAW data.

Specifically, the light emission frequency control unit 41 controls the light emitting unit 21 in such a manner as to emit light at the second frequency set as the light emission frequency. The light emitting unit 21 emits modulated light modulated at the second frequency set by the light emission frequency control unit 41. Under the exposure control by the exposure time calculation unit 44, the sensor 22 receives reflected light being the modulated light that has been emitted by the light emitting unit 21 and reflected off a subject. The sensor 22 accumulates the amount of light received, as the amount of electric charge, in the light receiving unit, and outputs the amount of electric charge accumulated in the light receiving unit, as the second RAW data, to the signal strength calculation unit 42 and the distance measurement unit 43. The signal strength calculation unit 42 and the distance measurement unit 43 acquire the second RAW data.

In step S18, the signal strength calculation unit 42 calculates signal strength from the signal value of the second RAW data supplied from the sensor 22, and outputs the calculated signal strength to the exposure time calculation unit 44. The exposure time calculation unit 44 calculates, in the determined target area, the second exposure time for the second distance measurement at the second frequency for the next frame in such a manner that the signal strength supplied from the signal strength calculation unit 42 is at an appropriate level.

In step S19, the exposure time calculation unit 44 sets the first and second exposure times calculated in steps S12 and S18, as the first exposure time and the second exposure time for the next frame, respectively.

In step S20, the distance measurement unit 43 calculates a distance from the subject on the basis of the second RAW data supplied from the sensor 22 and the second frequency, and generates the second distance image. The distance measurement unit 43 outputs the generated second distance image to the distance image synthesis unit 47.

In step S21, the distance image synthesis unit 47 synthesizes the first and second distance images supplied from the distance measurement unit 43, and outputs the synthesized distance image to the output unit 48. The output unit 48 outputs the synthesized distance image to the unillustrated subsequent stage.

After step S21, the procedure of FIG. 10 ends.

Note that the above-mentioned processes of steps S18 and S19 and processes of S20 and S21 are performed in parallel as illustrated in FIG. 8.

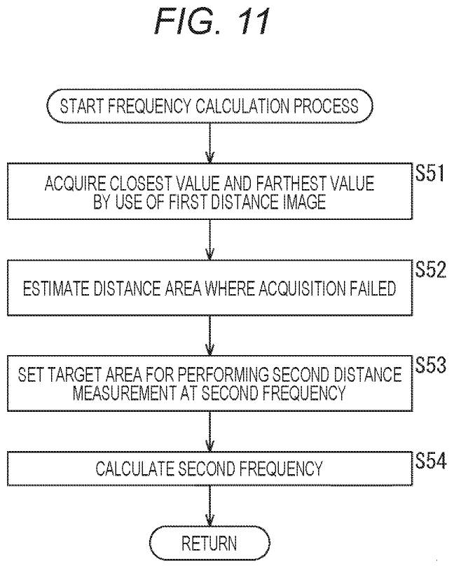

FIG. 11 is a flowchart explaining the frequency calculation process in step S14 of FIG. 10.

In step S51, the area setting unit 45 acquires the closest value and the farthest value by use of the first distance image supplied from the distance measurement unit 43 to estimate a distance range where a pixel value was successfully acquired.

In step S52, the area setting unit 45 estimates a distance area where a pixel value failed to be acquired in the first distance measurement on the basis of the distance range where the pixel value was successfully acquired.

In step S53, the area setting unit 45 sets the estimated distance area as a target area for performing the second distance measurement at the second frequency.

In step S54, the frequency calculation unit 46 calculates the second frequency at which a distance can be measured for the set target area.

### <<4. Second Embodiment (A Plurality of Light Emitting Units)>>

<Configuration of iToF Sensor>

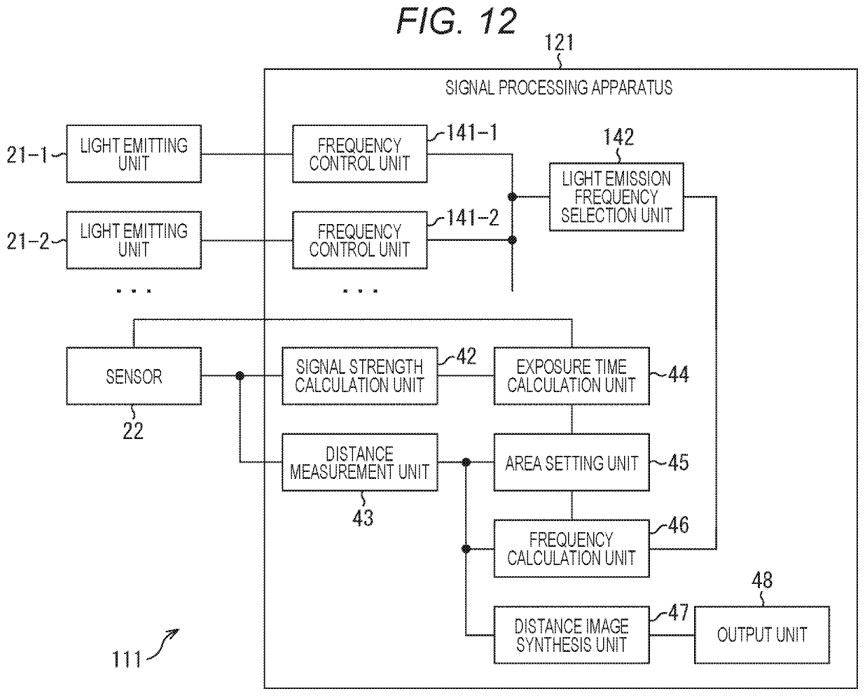

FIG. 12 is a block diagram illustrating a configuration example of a second embodiment of an iToF sensor to which the present technology is applied.

In FIG. 12, an iToF sensor 111 includes light emitting units 21-1 to 21-n supporting respective fixed frequencies thereof, a sensor 22, and a signal processing apparatus 121. In FIG. 12, corresponding reference signs are assigned to portions corresponding to those in FIG. 7, and descriptions thereof are omitted.

The signal processing apparatus 121 includes frequency control units 141-1 to 141-n, a light emission frequency selection unit 142, a signal strength calculation unit 42, a distance measurement unit 43, an exposure time calculation unit 44, an area setting unit 45, a frequency calculation unit 46, a distance image synthesis unit 47, and an output unit 48.

The frequency control units 141-1 to 141-n are configured, corresponding to the light emitting units 21-1 to 21-n for the respective frequencies thereof.

The frequency control units 141-1 to 141-n control the corresponding light emitting units 21-1 to 21-n in such a manner as to emit light at their corresponding frequencies under the control of the light emission frequency selection unit 142.

The light emission frequency selection unit 142 selects the same frequency as the second frequency determined by the frequency calculation unit 46, as the light emission frequency, among the frequencies supported by the frequency control units 141-1 to 141-n. The light emission frequency selection unit 142 causes the frequency control units 141-1 to 141-n supporting the same frequency as the second frequency selected as the light emission frequency to control light emission of the corresponding light emitting units 21-1 to 21-n.

In a case where there is no frequency control unit 141-n supporting the same frequency as the second frequency, the light emission frequency selection unit 142 selects the frequency that is the closest to the second frequency determined by the frequency calculation unit 46, as the light emission frequency, among the frequencies supported by the frequency control units 141-1 to 141-n.

Note that the light emitting units 21-1 to 21-n are referred to as the light emitting unit 21 in a case where it is not particularly necessary to distinguish the light emitting units 21-1 to 21-n. The frequency control units 141-1 to 141-n are referred to as the frequency control unit 141 in a case where it is not particularly necessary to distinguish the frequency control units 141- to 141-n.

<Operation of iToF Sensor>

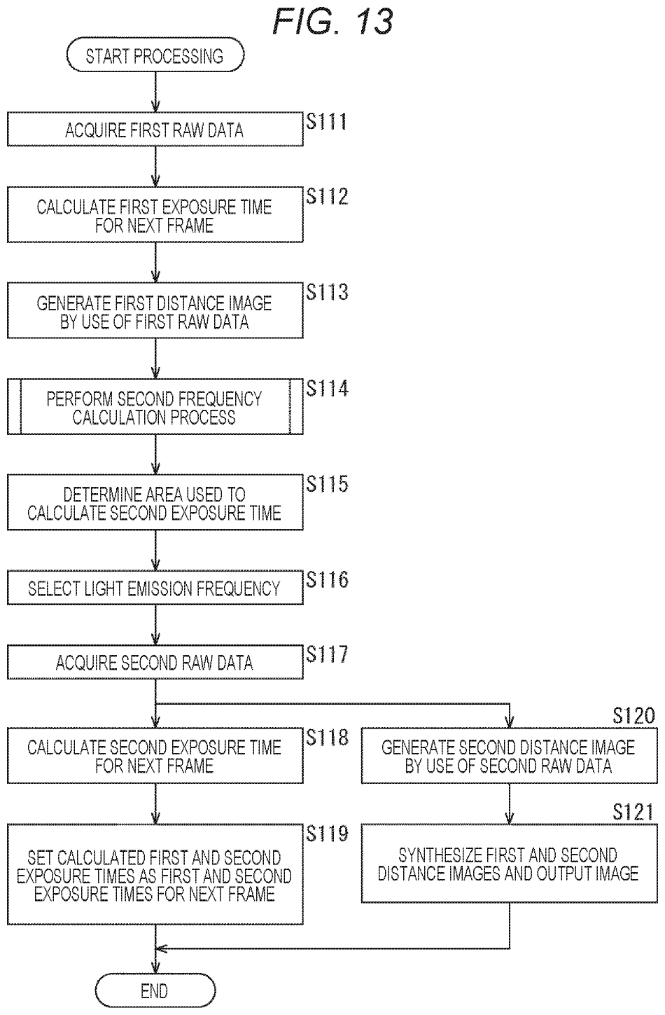

FIG. 13 is a flowchart explaining the processes of the iToF sensor 111 of FIG. 12.

Note that processes in steps S111 to S115 and steps S117 to S121 in FIG. 13 are similar to the processes in steps S11 to S15 and steps S17 to S21 in FIG. 10, and therefore descriptions thereof are omitted.

In step S114 of FIG. 13, information indicating the target area set by the area setting unit 45 is outputted to the exposure time calculation unit 44 and the frequency calculation unit 46. The second frequency calculated by the frequency calculation unit 46 is outputted to the light emission frequency control unit 41.

In step S115, the exposure time calculation unit 44 determines the target area set by the area setting unit 45 as an area used for exposure control and calculation of the second exposure time for the second distance measurement with modulated light at the second frequency for the next frame. Thereafter, the procedure moves on to step S116.

In S116, the light emission frequency selection unit 142 selects the same frequency as the second frequency determined by the frequency calculation unit 46, as the light emission frequency, among the frequencies supported by the frequency control units 141-1 to 141-2. The light emission frequency selection unit 142 causes the frequency control units 141-1 to 141-2 supporting the same frequency as the second frequency selected as the light emission frequency to control light emission of the corresponding light emitting units 21-1 to 21-n.

### <<5. Others>>

### <Effect>

As described above, in the present technology, when reflected light that is modulated light at a predetermined frequency, the modulated light being modulated at the predetermined frequency, emitted from the light emitting unit, and reflected off a subject, is received, and an image of the subject is captured, a distance to the subject is calculated on the basis of the amount of electric charge acquired from the light receiving unit that accumulates the amount of light received, as the amount of electric charge, and the predetermined frequency. A distance image is generated. Then, a target area targeted for the exposure control for capturing an image of the subject by use of the modulated light at the second frequency is set on the basis of the first distance image generated at the time of capturing an image of the subject by use of the modulated light at the first frequency, and the second frequency is calculated on the basis of the target area. Therefore, highly accurate distance measurement can be performed over a wide range.

### <Program>

The above-mentioned series of processes can be executed by hardware or can be executed by software. In a case where the series of processes is executed by software, a program included in the software is installed from a program recording medium to, for example, a computer incorporated in dedicated hardware, or a general-purpose personal computer.

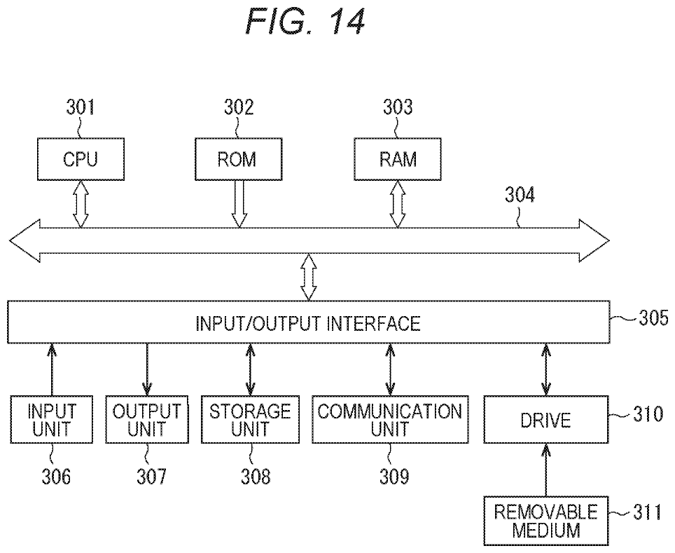

FIG. 14 is a block diagram illustrating a configuration example of hardware of a computer that causes a program to execute the above-mentioned series of processes.

A CPU 301, a Read Only Memory (ROM) 302, and a RAM 303 are connected to one another by a bus 304.

Moreover, the bus 304 is connected to an input/output interface 305. The input/output interface 305 is connected to an input unit 306 including a keyboard, a mouse and the like, and an output unit 307 including a display, a speaker and the like. Furthermore, the input/output interface 305 is connected to a storage unit 308 including a hard disk, a non-volatile memory and the like, a communication unit 309 including a network interface and the like, and a drive 310 that drives a removable medium 311.

In the computer configured as described above, for example, the CPU 301 loads a program stored in the storage unit 308 into the RAM 303 via the input/output interface 305 and the bus 304, and executes the program to perform the above-mentioned series of processes.

The program to be executed by the CPU 301 is provided, for example, by being recorded in the removable medium 311 or via a wired or wireless transmission medium such as a local area network, the Internet, or digital broadcasting, and is installed in the storage unit 308.

Note that the program to be executed by the computer may be a program that performs the processes in time series in the order described in the present description, or may be a program that performs the processes in parallel or at necessary timings such as when calls are made.

Note that, in the present description, a system means an assembly of a plurality of components (such as devices and modules (parts)) and it does not matter whether or not all the components are in the same housing. Consequently, both of a plurality of devices stored in different housings and connected via a network, and one device in which a plurality of modules is stored in one housing are systems.

Furthermore, the effect described in the present description is a merely example and is not limited, and there may also be other effects.

Embodiments of the present technology are not limited to the above-mentioned embodiments, and various modifications can be made without departing from the gist of the present technology.

For example, the present technology can take a configuration of cloud computing where one function is shared by a plurality of devices via a network and processed in collaboration.

Furthermore, each step described in the above-mentioned flowcharts can be executed by one device, and also shared and executed by a plurality of devices.

Moreover, in a case where one step includes a plurality of processes, the plurality of processes included in the one step can be executed by one device, and also shared and executed by a plurality of devices.

### <Configuration Combination Examples>

The present technology can also employ the following configurations:

(1)

A signal processing apparatus including:
a distance measurement unit that calculates a distance to a subject on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and generates a distance image;
an area setting unit that sets a target area targeted for exposure control for measuring a distance by use of modulated light at a second frequency, on the basis of a first distance image generated at the time of measuring a distance by use of modulated light at a first frequency; and
a frequency calculation unit that calculates the second frequency on the basis of the target area.

(2)

The signal processing apparatus according to (1),
in which the frequency calculation unit determines the second frequency on the basis of a distance from the light receiving unit to an area where a pixel value failed to be obtained in the first distance image.

(3)

The signal processing apparatus according to (2),
in which the frequency calculation unit determines a third frequency in a case where the first distance image, and a second distance image generated at the time of measuring a distance by use of the modulated light at the second frequency include an area where a pixel value failed to be obtained.

(4)

The signal processing apparatus according to (2),
in which the area setting unit sets, as the target area, an area where the pixel value failed to be obtained due to saturation in the first distance image.

(5)

The signal processing apparatus according to (2),
in which the area setting unit sets, as the target area, an area where the pixel value failed to be obtained due to low luminance in the first distance image.

(6)

The signal processing apparatus according to (2), in which the area setting unit sets, as the target area, an area including an object recognized in the first distance image.

(7)

The signal processing apparatus according to (2),
in which the area setting unit sets, as the target area, an area based on a distance or an area in the first distance image, the area being designated by a user.

(8)

The signal processing apparatus according to any of (1) to (7), further including
an exposure control unit that performs the exposure control for setting an exposure for the target area set by the area setting unit upon measuring a distance by use of the second frequency.

(9)

The signal processing apparatus according to (8), further including an exposure time calculation unit that calculates an exposure time on the basis of the amount of electric charge,
in which the exposure control unit performs the exposure control on the basis of the calculated exposure time.

(10)

The signal processing apparatus according to (9),
in which the exposure time calculation unit calculates the amount of light necessary for exposure, and
the exposure control unit performs the exposure control on the basis of the exposure time and the amount of light.

(11)

The signal processing apparatus according to any of (1) to (10), further including:
the light emitting unit; and
the light receiving unit.

(12)

The signal processing apparatus according to (11),
in which the light emitting unit emits the modulated light at the first frequency and the modulated light at the second frequency.

(13)

The signal processing apparatus according to (11),
in which the light emitting unit includes a first light emitting unit that emits the modulated light at the first frequency, and a second light emitting unit that emits the modulated light at the second frequency.

(14)

The signal processing apparatus according to (11),
in which the light emitting unit includes a plurality of the light emitting units, and the light emitting unit with a frequency closest to the second frequency calculated by the frequency calculation unit among the plurality of the light emitting units emits the modulated light.

(15)

A signal processing method causing a signal processing apparatus to:
calculate a distance to a subject on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and generate a distance image;
set a target area targeted for exposure control for measuring a distance by use of modulated light at a second frequency, on the basis of a first distance image generated at the time of measuring a distance by use of modulated light at a first frequency; and calculate the second frequency on the basis of the target area.

(16)

A program causing a computer to function as:
a distance measurement unit that calculates a distance to a subject on the basis of the amount of electric charge acquired from a light receiving unit that accumulates, as the amount of electric charge, the amount of reflected light received, the reflected light being modulated light reflected off the subject at the time of measuring the distance by use of the modulated light at a predetermined frequency, the modulated light being emitted from a light emitting unit, and on the basis of the predetermined frequency, and generates a distance image;
an area setting unit that sets a target area targeted for exposure control for measuring a distance by use of modulated light at a second frequency, on the basis of a first distance image generated at the time of measuring a distance by use of modulated light at a first frequency; and a frequency calculation unit that calculates the second frequency on the basis of the target area.

### REFERENCE SIGNS LIST

11 iToF sensor
21 Light emitting unit
22 Sensor
23 Signal processing apparatus
41 Light emission frequency control unit
42 Signal strength calculation unit
43 Distance measurement unit
44 Exposure time calculation unit
45 Area setting unit
46 Frequency calculation unit
47 Distance image synthesis unit
48 Output unit

1. A signal processing apparatus comprising:
a distance measurement unit that calculates a distance to a subject on a basis of an amount of electric charge acquired from a light receiving unit that accumulates, as the amount of electric charge, an amount of reflected light received, the reflected light being modulated light reflected off the subject at a time of measuring the distance by use of the modulated light at a predetermined frequency, the modulated light being emitted from a light emitting unit, and on a basis of the predetermined frequency, and generates a distance image;
an area setting unit that sets a target area targeted for exposure control for measuring a distance by use of modulated light at a second frequency, on a basis of a first distance image generated at a time of measuring a distance by use of modulated light at a first frequency; and
a frequency calculation unit that calculates the second frequency on a basis of the target area.

2. The signal processing apparatus according to claim 1,
wherein the frequency calculation unit determines the second frequency on a basis of a distance from the light receiving unit to an area where a pixel value failed to be obtained in the first distance image.

3. The signal processing apparatus according to claim 2,
wherein the frequency calculation unit determines a third frequency in a case where the first distance image, and a second distance image generated at a time of measuring a distance by use of the modulated light at the second frequency include an area where a pixel value failed to be obtained.

4. The signal processing apparatus according to claim 2,
wherein the area setting unit sets, as the target area, an area where the pixel value failed to be obtained due to saturation in the first distance image.

5. The signal processing apparatus according to claim 2,
wherein the area setting unit sets, as the target area, an area where the pixel value failed to be obtained due to low luminance in the first distance image.

6. The signal processing apparatus according to claim 2,
wherein the area setting unit sets, as the target area, an area including an object recognized in the first distance image.

7. The signal processing apparatus according to claim 2,
wherein the area setting unit sets, as the target area, an area based on a distance or an area in the first distance image, the area being designated by a user.

8. The signal processing apparatus according to claim 1, further comprising
an exposure control unit that performs the exposure control for setting an exposure for the target area set by the area setting unit upon measuring a distance by use of the second frequency.

9. The signal processing apparatus according to claim 8, further comprising
an exposure time calculation unit that calculates an exposure time on a basis of the amount of electric charge,
wherein the exposure control unit performs the exposure control on a basis of the calculated exposure time.

10. The signal processing apparatus according to claim 9,
wherein the exposure time calculation unit calculates the amount of light necessary for exposure, and
the exposure control unit performs the exposure control on a basis of the exposure time and the amount of light.

11. The signal processing apparatus according to claim 1, further comprising:
the light emitting unit; and
the light receiving unit.

12. The signal processing apparatus according to claim 11,
wherein the light emitting unit emits the modulated light at the first frequency and the modulated light at the second frequency.

13. The signal processing apparatus according to claim 11,
wherein the light emitting unit includes a first light emitting unit that emits the modulated light at the first frequency, and a second light emitting unit that emits the modulated light at the second frequency.

14. The signal processing apparatus according to claim 11,
wherein the light emitting unit comprises a plurality of the light emitting units, and
the light emitting unit with a frequency closest to the second frequency calculated by the frequency calculation unit among the plurality of the light emitting units emits the modulated light.

15. A signal processing method causing a signal processing apparatus to:
calculate a distance to a subject on a basis of an amount of electric charge acquired from a light receiving unit that accumulates, as the amount of electric charge, an amount of reflected light received, the reflected light being modulated light reflected off the subject at a time of measuring the distance by use of the modulated light at a predetermined frequency, the modulated light being emitted from a light emitting unit, and on a basis of the predetermined frequency, and generate a distance image;
set a target area targeted for exposure control for measuring a distance by use of modulated light at a second frequency, on a basis of a first distance image generated at a time of measuring a distance by use of modulated light at a first frequency; and
calculate the second frequency on a basis of the target area.

16. A program causing a computer to function as:
a distance measurement unit that calculates a distance to a subject on a basis of an amount of electric charge acquired from a light receiving unit that accumulates, as the amount of electric charge, an amount of reflected light received, the reflected light being modulated light reflected off the subject at a time of measuring the distance by use of the modulated light at a predetermined frequency, the modulated light being emitted from a light emitting unit, and on a basis of the predetermined frequency, and generates a distance image;
an area setting unit that sets a target area targeted for exposure control for measuring a distance by use of modulated light at a second frequency, on a basis of a first distance image generated at a time of measuring a distance by use of modulated light at a first frequency; and
a frequency calculation unit that calculates the second frequency on a basis of the target area.
